(19) United States
(12) Patent Application Publication
(10) Pub. No.: US 2011/0145765 A1
(43) Pub. Date: Jun. 16, 2011

(54) MENU NAVIGATION METHOD, APPARATUS AND USER INTERFACE HAVING MENU NAVIGATION FUNCTION, AND RECORDING MEDIUM HAVING RECORDED THEREON PROGRAM FOR EXECUTING THE MENU NAVIGATION METHOD

(75) Inventors: Seung-dong Yu, Osan-si (KR); Jung-A Kim, Anyang-si (KR); Chang-seog Ko, Hwaseong-si (KR)

(73) Assignee: SAMSUNG ELECTRONICS CO., LTD., Suwon-si (KR)

(21) Appl. No.: 13/059,143

(22) PCT Filed: May 15, 2009
(86) PCT No.: PCT/KR09/02576

§ 371 Date: Feb. 15, 2011

(30) Foreign Application Priority Data
Aug. 18, 2008 (KR) 10-2008-0080563

(51) Int. Cl. G06F 3/048

(52) U.S. Cl. 715/835; 715/841

(57) ABSTRACT

Provided are a menu navigation method using a user interface (UI), an apparatus and UI having a menu navigation function, and a computer readable recording medium having recorded thereon a program for executing the menu navigation method. The menu navigation method includes: displaying a first screen on which at least one menu item is arranged based on an arc type line; and when a menu item is selected based on the first screen, displaying the selected menu item on an inner side of the arc type line and displaying a second screen on which at least one menu item is arranged on an outer side of the arc type line, wherein the at least one menu item of the second screen is at least one lower layer menu item of the selected menu item.

### TECHNICAL FIELD

Exemplary embodiments of the present invention relate to menu navigation, and more particularly, to menu navigation using a user interface (UI).

### BACKGROUND ART

Electronic apparatuses, such as televisions (TVs), digital still cameras (DSCs), home theater systems, content reproducing apparatuses, multimedia apparatuses, and mobile terminals, are becoming capable of performing operations such as setting or controlling various functions or selecting content to be reproduced, based on a menu navigation function using a user interface (UI).

### DISCLOSURE OF INVENTION

### Technical Solution

The present invention provides a menu navigation method, an apparatus and a user interface (UI) having a menu navigation function, and a computer-readable recording medium having recorded thereon a program for executing the menu navigation method.

### DESCRIPTION OF DRAWINGS

The above and other features of the present invention will become more apparent by describing in detail exemplary embodiments thereof with reference to the attached drawings in which:

FIG. 1 is a functional block diagram illustrating an apparatus having a menu navigation function, according to an exemplary embodiment of the present invention;

FIG. 2 is a diagram illustrating screens of a user interface (UI), according to an exemplary embodiment of the present invention;

FIG. 3 is a diagram illustrating screens of a UI, according to another exemplary embodiment of the present invention;

FIG. 4 is a diagram illustrating an application of the screens of FIG. 2 in a digital television (DTV), according to an exemplary embodiment of the present invention;

FIG. 5 is a diagram illustrating another application of the screens of FIG. 2 in a DTV, according to another exemplary embodiment of the present invention;

FIG. 6 is a diagram illustrating screens of a UI, according to another exemplary embodiment of the present invention;

FIG. 7 is a diagram illustrating an application of the screens of FIG. 6 in a blu-ray disc system, according to an exemplary embodiment of the present invention;

FIG. 8 is a diagram illustrating another application of the screens of FIG. 6 in a blu-ray disc system, according to another exemplary embodiment of the present invention;

FIG. 9 is a diagram illustrating an application of the screens of FIG. 6 in a digital still camera, according to an exemplary embodiment of the present invention;

FIG. 10 is a diagram illustrating an application of screens of a UI in an MP3 player (MP3P), according to an exemplary embodiment of the present invention; and

FIG. 11 is a flowchart of a menu navigation method, according to an exemplary embodiment of the present invention.

### BEST MODE

According to an exemplary embodiment of the present invention, there is provided a menu navigation method, including: displaying a first screen on which at least one menu item is arranged based on an arc type line; and when a menu item is selected based on the first screen, displaying a second screen on which the selected menu item is displayed on an inner side of the arc type line and at least one menu item is arranged on an outer side of the arc type line, wherein the at least one menu item arranged on the outer side of the arc type line of the second screen is at least one lower layer menu item of the selected menu item.

When each of the first and second screens includes a lower layer menu item of a designated menu item from among the displayed at least one menu item, each of the first screen and the second screen may include a preview area displaying the lower layer menu item, wherein the menu navigation method further comprises when the designated menu item is selected, changing the preview area to a selectable area.

The menu navigation method may further include when the preview area is changed to the selectable area, changing a display location of the arc type line so that a display area of the inner side of the arc type line is reduced.

The menu navigation method may further include displaying a lowest layer menu item of the menu item selected in the first screen as a pop-up screen.

The menu navigation method may further include displaying the menu item designated in the first screen, the second screen, or the pop-up screen differently from undesignated menu items in the first screen, the second screen, or the pop-up screen.

The displaying of the first screen may include displaying at least one of a menu item name and an icon of the at least one menu item arranged based on the arc type line, and wherein the displaying of the second screen may include displaying at least one of a menu item name and an icon of the selected menu item on the inner side of the arc type line.

The menu navigation method may further include when the lowest layer menu item of the selected menu item is selected, displaying a third screen, on which the lowest layer menu item of a lowest layer and the selected menu item are arranged based on an arc type line of the lowest layer and includes information about the selected menu item.

The menu navigation method may further include displaying an arc type line between upper layer menu items and lower layer menu items.

The menu navigation method may further include when a menu item is selected from each layer, changing a location of an arc type line of a layer corresponding to the selected menu item so as to reduce a display area of the layer corresponding to the selected menu item.

According to another aspect of the present invention, there is provided a user interface (UI) including: displaying a first screen on which at least one menu item is arranged based on an arc type line; and when a menu item is selected based on the first screen, displaying a second screen on which the selected menu item is displayed on an inner side of the arc type line and at least one menu item is arranged on an outer side of the arc type line, wherein the at least one menu item arranged on the outer side of the arc type line of the second screen is at least one lower layer menu item of the selected menu item.

According to another aspect of the present invention, there is provided a computer readable recording medium having recorded thereon a program for executing a menu navigation method including: displaying a first screen on which at least one menu item is arranged based on an arc type line; and when a menu item is selected based on the first screen, displaying a second screen on which the selected menu item is displayed on an inner side of the arc type line and at least one menu item is arranged on an outer side of the arc type line, wherein the at least one menu item arranged on the outer side of the arc type line of the second screen is at least one lower layer menu item of the selected menu item.

According to another aspect of the present invention, there is provided an electronic apparatus including: a UI displaying a menu screen, on which at lest one menu item is arranged based on an arc type line and which displays a lower layer menu item of a menu item designated from among the at least one menu item on a preview area; and a controller, when a menu item is selected from the menu screen, which displays the selected menu item in an inner side of the arc type line and provides information about changing the preview area to a selectable area to the UI.

The electronic apparatus may further include a menu management unit storing and managing selectable menu items that are classified according to menu items in a hierarchical structure, wherein the controller provides information about a screen formed according to menu item information obtained from the menu management unit to the UI, based on received information.

### MODE FOR INVENTION

Hereinafter, the present invention will be described more fully with reference to the accompanying drawings, in which exemplary embodiments of the invention are shown.

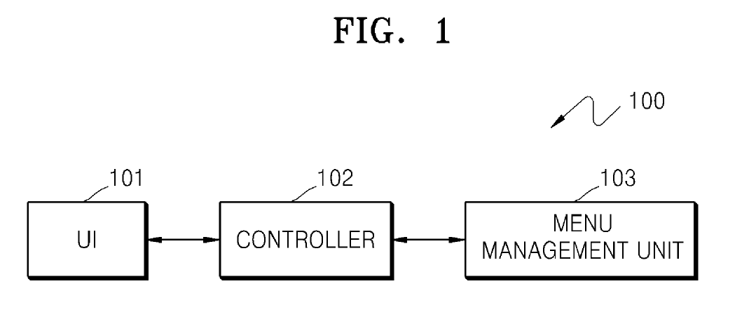

FIG. 1 is a functional block diagram illustrating an apparatus 100 having a menu navigation function, according to an exemplary embodiment of the present invention. Referring to FIG. 1, the apparatus includes a user interface (UI) 101, a controller 102, and a menu management unit 103. The apparatus 100 may further include a function execution unit (not shown), which performs a function controlled according to a menu item selected via the UI 101, or a reproduction processor (not shown), which reproduces content.

The apparatus 100 may be applied to, for example, a television (TV), a digital still camera (DSC), a home theater system (HTS), a content reproducing apparatus, a multimedia apparatus, a mobile terminal, an internet protocol television (IPTV), or an MPEG-1 Audio Layer 3 player (MP3P).

When a menu is requested, the UI 101 transmits a menu request signal to the controller 102. The menu request signal may be transmitted by using a remote controller (not shown) or based on input information provided via the UI 101. When the remote controller is used, the apparatus 100 may further include a remote control receiver (not shown). The input information provided via the UI 101 may be displayed on a screen of the UI 101.

When the menu request signal is received, the controller 102 obtains information for forming a menu screen from the menu management unit 103. The information for forming a menu screen may be determined according to functions provided by the apparatus 100.

In other words, when the apparatus 100 is a TV, the information in the menu management unit 103 is determined in such a way that the controller 102 receives pictures, sound, channels, setups, inputs, application, etc. as top menu items of the menu screen from the menu management unit 103.

When the apparatus 100 is a DSC, the information in the menu management unit 103 is determined in such a way that the controller 102 receives functions, sound, displays, settings, etc. as top menu items of the menu screen from the menu management unit 103.

When the apparatus 100 is an HTS, the information in the menu management unit 103 is determined in such a way that the controller 102 receives videos, music, photos, setups, etc. as top menu items of the menu screen from the menu management unit 103.

When the apparatus 100 is an MP3P, the information in the menu management unit 103 is determined in such a way that the controller 102 receives music, videos, pictures, radio, data casts, etc. as top menu items of the menu screen from the menu management unit 103.

The menu management unit 103 may store and manage information about menu items in a hierarchical structure so that lower layer items classified according to each top menu item are obtained. At least one lower layer may exist for each top menu item. A number of lower layers according to each top menu item and a relation between an upper layer menu item and lower layer menu items may be determined according to the functions provided by the apparatus 100.

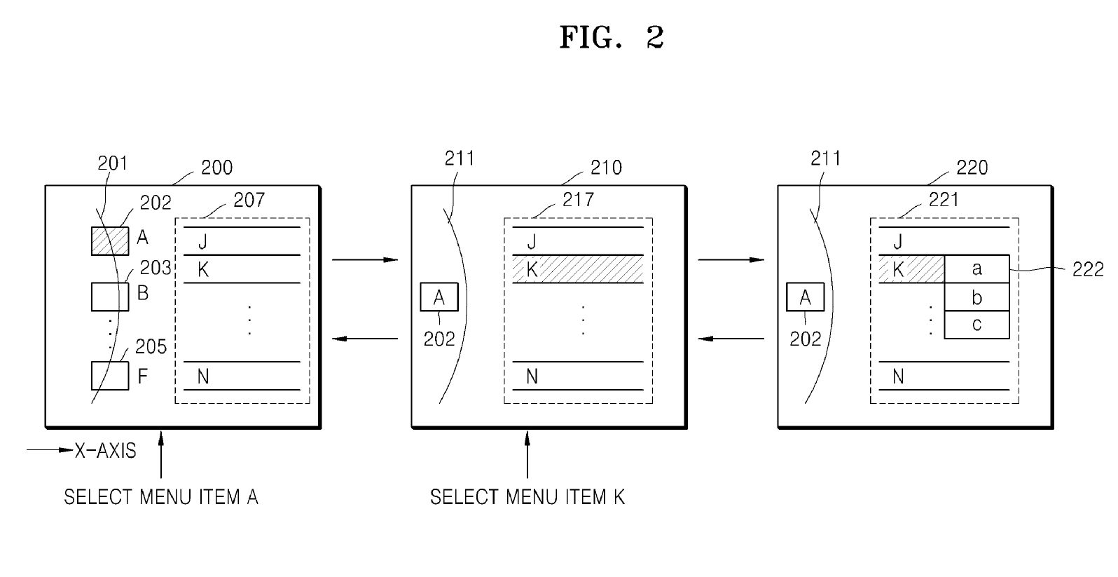

Upon receiving the information for forming a menu screen from the menu management unit 103, the controller 102 provides a menu screen such as a screen 200 illustrated in FIG. 2 to the UI 101.

FIG. 2 is a diagram illustrating screens of the UI 101, according to an exemplary embodiment of the present invention. A screen 200 is an initial menu screen, which displays an arc type line 201 on the left of the screen 200 and on which menu items A 202 and B 203 through F 205, which are top menu items, are arranged based on the arc type line 201. In FIG. 2, A through F are top menu item names, and each box is an icon corresponding to each of the menu items A 202 through F 205. Alternatively, the controller 102 may arrange one of the top menu item names and icons based on the arc type line 201.

In FIG. 2, the menu item A 202 is a designated screen, and thus includes a preview area 207 about lower layer menu items of the menu item A 202. The menu item A 202 may be designated as a default or designated by a user. The screen 200 may display the designated menu item A 202 in such a way that the menu item A 202 is distinguished from other undesignated menu items B 203 through F 205. For example, the menu item A 202 may be highlighted or displayed in a different color to be distinguished from the menu items B 203 through F 205. The preview area 207 may be transparent. Accordingly, before selecting the menu item A 202, a user can consider selecting the top menu item A 202 by previewing lower layer menu items of the menu item A 202.

When the user changes a designated menu item to the menu item B 203 in the screen 200 based on the UI 101, lower layer menu items displayed in the preview area 207 are changed to lower layer menu items of the menu item B 203, and the menu item B 203 may be highlighted. Accordingly, before selecting the menu item B 203, a user can consider selecting the menu item B 203 by previewing the lower layer menu items of the menu item B 203. Here, when the menu item B 203 does not include any lower layer menu item, the screen 200 may not include the preview area 207.

When the menu item A 202 is selected in the screen 200 via the UI 101, the screen 200 is converted to the screen 210. In the screen 210, only the icons of the selected menu item A 202 are displayed at an inner side of an arc type line 211, and other menu items B 203 through F 205 are not displayed.

At least one of a menu item name and an icon of the selected menu item A 202 may be displayed at the inner side of the arc type line 211. The inner side of the arc type line 211 is a display area at a side away from which the arc type line 211 is bending, based on the arc type line 211. In FIG. 2, a left display area based on the arc type line 211 is the inner side of the arc type line 211. An outer side of the arc type line 211 is a display area opposite the inner side in the entire display area divided based on the arc type line 211. In FIG. 2, a right display area based on the arc type line 211 is the outer side of the arc type line 211.

A display area in an x-axis direction is reduced in the inner side of the arc type line 211 compared to in the display area of the inner side of the arc type line 201, as a display location of the arc type line 211 in the screen 210 is transferred to the left compared to the arc type line 201 in the screen 200. Meanwhile, an area 217 corresponding to the preview area 207 is changed to a selectable area, and thus a display area in an x-axis direction of the area 217 increases. The display area in an x-axis direction may vary so as to obtain a larger selectable display area, without displaying unnecessary information on the screen 210.

When a menu item K is selected from among selectable lower layer menu items in the screen 210 and lower layer menu items of the menu item K are lowest layer menu items, the lower layer menu items of the menu item K are displayed in a pop-up screen 222 as shown in the screen 220. Accordingly, a depth of a menu screen displayed on the UI 101 may be reduced.

As illustrated in FIG. 2, menu navigation may be used in order to control a setup menu or a certain function of the apparatus 100. For example, when the menu item A 202 is ‘Picture’, the menu item K is ‘color’, a menu item a is ‘cool’, a menu item b is ‘normal’, and a menu item c is ‘warm’, the controller 102 sets a color of a picture to be displayed in the apparatus 100 to a normal mode when a user selects the menu item b based on the menu screens 200, 210, and 220 shown in the order illustrated in FIG. 2. A screen 221 corresponds to the screen 217 and is a selectable area.

When a signal requesting to return to a previous screen is input while the screen 220 is being displayed on the UI 101, the controller 102 changes the screen 220 to a previous screen, i.e. to the screen 210. Also, when the signal requesting to return to a previous screen is input while the screen 210 is being displayed on the UI 101, the controller 102 changes the screen 210 to a previous screen, i.e. to the screen 200. The signal requesting to return to a previous screen may be similarly input as the menu request signal. In other words, the signal requesting to return to a previous screen may be input by using a return key, a direction key, or an exclusive key on a request signal input screen provided via the remote controller or the UI 101. The exclusive key is a key requesting to return to a previous screen.

As illustrated in FIG. 2, the menu items A 202 through F 205 are top layer menu items. Lower layers of the top menu item A 202 comprise two layers, the menu items J through N are the lower layer menu items of the menu item A 202, and the menu items a, b, and c are lower layer menu items of the menu item K and lowest layer menu items of the menu item A 202. Accordingly, when the menu item A 202 is selected, the menu items a, b, and c become the lowest layer menu items of the selected menu item.

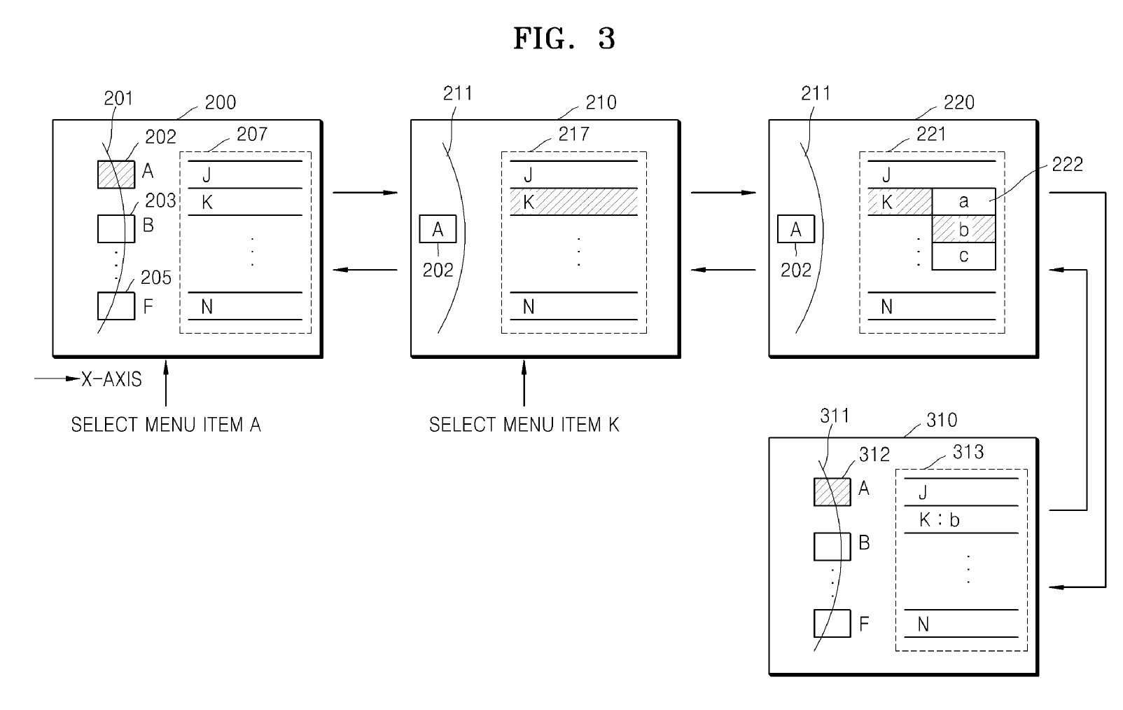

FIG. 3 is a diagram illustrating screens of the UI 101, according to another exemplary embodiment of the present invention, wherein the screen 310 is added to the screens 200, 210, and 220 of FIG. 2. A screen 310 is displayed when a lowest layer menu item of the selected menu screen is selected. In other words, when a menu item b, which is the lowest layer menu item of a selected menu item A 312, is selected, top layer menu items including the menu item A 312 are arranged based on an arc type line 311 and information about a selected menu item is displayed based on the selected menu item A 312. A display area 313 in the screen 310 may be a view area. The display area 313 displays the information about a selected menu item based on the selected menu item A 312.

Accordingly, a user may check selected content based on the screen 310, and then determine whether to operate the apparatus 100 based on the selected content. When the user does not wish to operate the apparatus 100 based on the selected content, the user may request to cancel the selected content by using the UI 101 or the remote controller. The user may change the selected content by transmitting the signal requesting to return to a previous screen described in FIG. 2.

The arrangement of menu items based on the arc type line 311 in the screen 310 is similar to the arrangement of menu items based on the arc type line 201 in the screen 200. Accordingly, a display area of an inner side of the arc type line 311 is similar to the display area of the inner side of the arc type line 201.

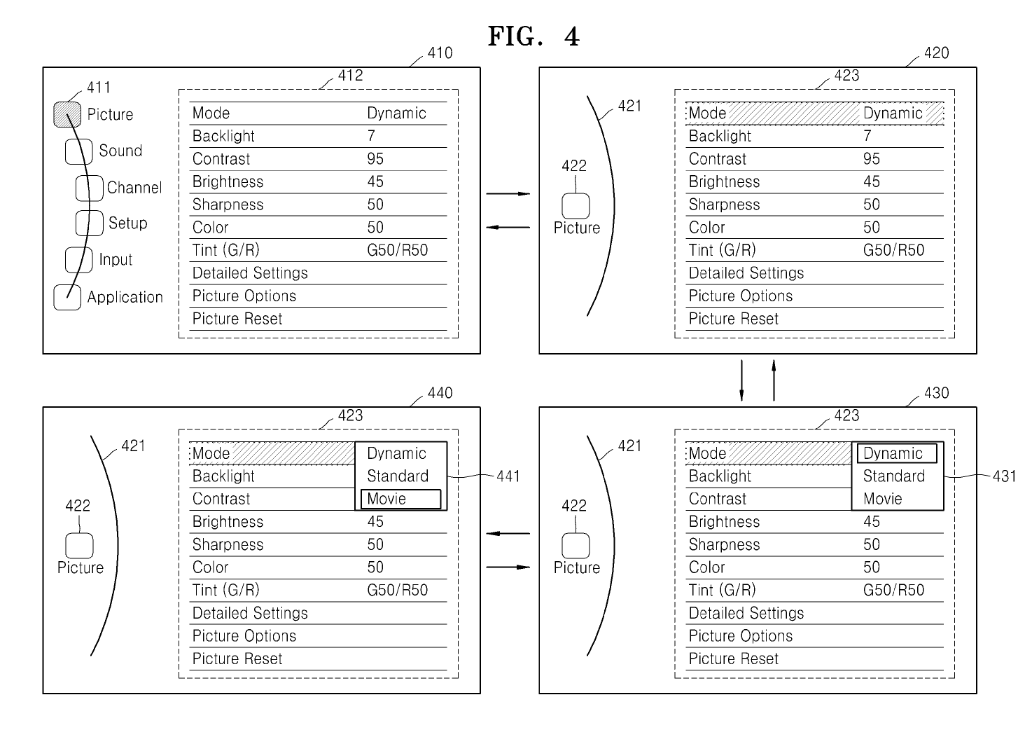

FIG. 4 is a diagram illustrating the application of the screens 200, 210, and 220 of FIG. 2 in a digital television (DTV), according to an exemplary embodiment of the present invention. Referring to FIG. 4, a screen 410 corresponds to the screen 200 of FIG. 2, and is a screen in which a menu item ‘Picture’ is designated from among menu items arranged on an arc type line 411 and lower layer menu items of the designated menu item ‘Picture’ are displayed in a preview area 412.

When the menu item ‘Picture’ is selected from the screen 410, a menu screen of the UI 101 is converted from the screen 410 to a screen 420. The screen 420 corresponds to the screen 210 of FIG. 2. A menu item name 422 of the menu item ‘Picture’ is displayed on an inner side of an arc type line 421 while other top menu items are not displayed, and the preview area 412 is converted to a selectable area 423. A display area of the selectable area 423 may be set to be bigger than a display area of the preview area 412, and a display area of the inner side of the arc type line 421 may be set to be smaller than a display area of the inner side of the arc type line 411. Such differences in display areas are possible by moving a display location of the arc type line 421 to the inner side while converting the screen 410 to the screen 420.

A screen 430 corresponds to the screen 220 of FIG. 2. Since lower layer menu items of a menu item ‘Mode’ are the lowest layer menu items of the menu item ‘Picture’, the lower layer menu items of the menu item ‘Mode’ are displayed in a pop-up screen 431. When a control signal for moving to a menu item ‘Movie’ from among the lower layer menu items on the pop-up screen 431 is input, the screen 430 is converted to a screen 440. The control signal may be input via the UI 101 or the remote controller. The screen 440 includes a pop-up screen 441 in which a designated menu item is changed to the menu item ‘Movie’.

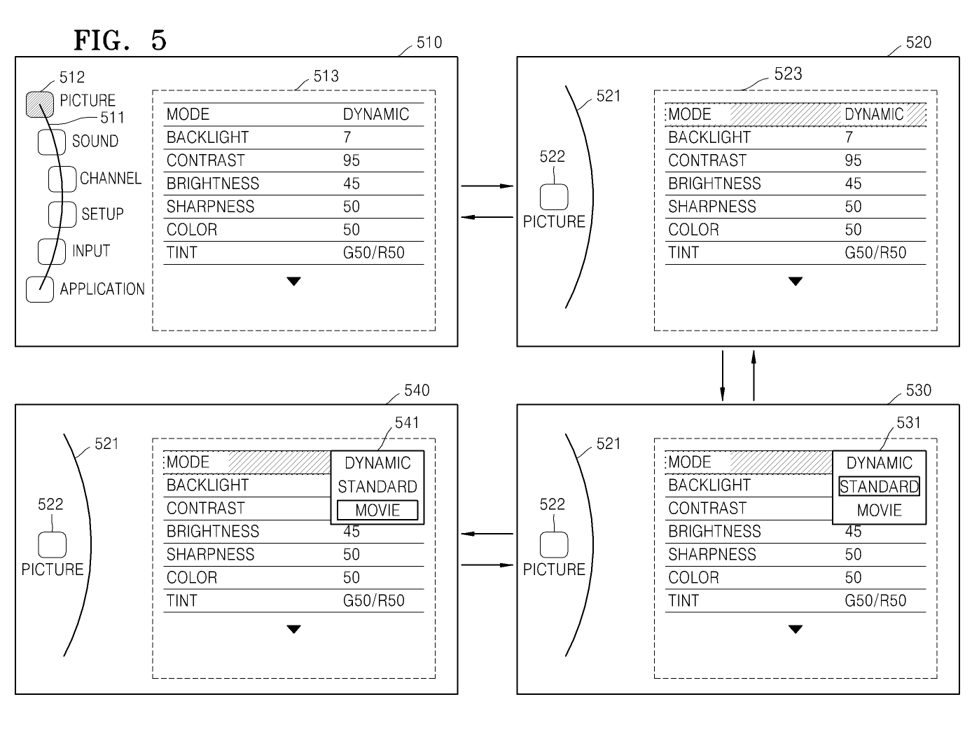

FIG. 5 is a diagram illustrating the application of the screens 200, 210, and 220 of FIG. 2 in a DTV, according to another exemplary embodiment of the present invention. A screen 510 of FIG. 5 corresponds to the screen 200 of FIG. 2, in which a menu item ‘Picture’ 512 is designated from among menu items arranged on an arc type line 511, and lower layer menu items of the designated menu item ‘Picture’ 512 are displayed in a preview area 513.

When the menu item ‘Picture’ 512 is selected from the screen 510, a menu screen of the UI 101 is converted from the screen 510 to a screen 520. The screen 520 corresponds to the screen 210 of FIG. 2. A menu item name 522 of the selected menu item ‘Picture’ 512 is displayed on an inner side of an arc type line 521 while other top menu items are not displayed, and the preview area 513 is converted to a selectable area 523. A display area of the selectable area 523 may be set to be bigger than a display area of the preview area 513, and a display area of the inner side of the arc type line 521 may be set to be smaller than a display area of the inner side of the arc type line 511. Such differences in the display areas are possible by moving a display location of the arc type line 521 to the inner side while converting the screen 510 to the screen 520.

A screen 530 corresponds to the screen 220 of FIG. 2. Since lower layer menu items of a menu item ‘Mode’ are the lowest layer menu items of the selected menu item ‘Picture’ 512, the lower layer menu items of the menu item ‘Mode’ are displayed on a pop-up screen 531. When a control signal for moving to a menu item ‘Movie’ from among the lower layer menu items on the pop-up screen 531 is input, the screen 530 is converted to a screen 540. The control signal may be input via the UI 101 or the remote controller. The screen 540 includes a pop-up screen 541 in which a designated menu item is changed to the menu item ‘Movie’.

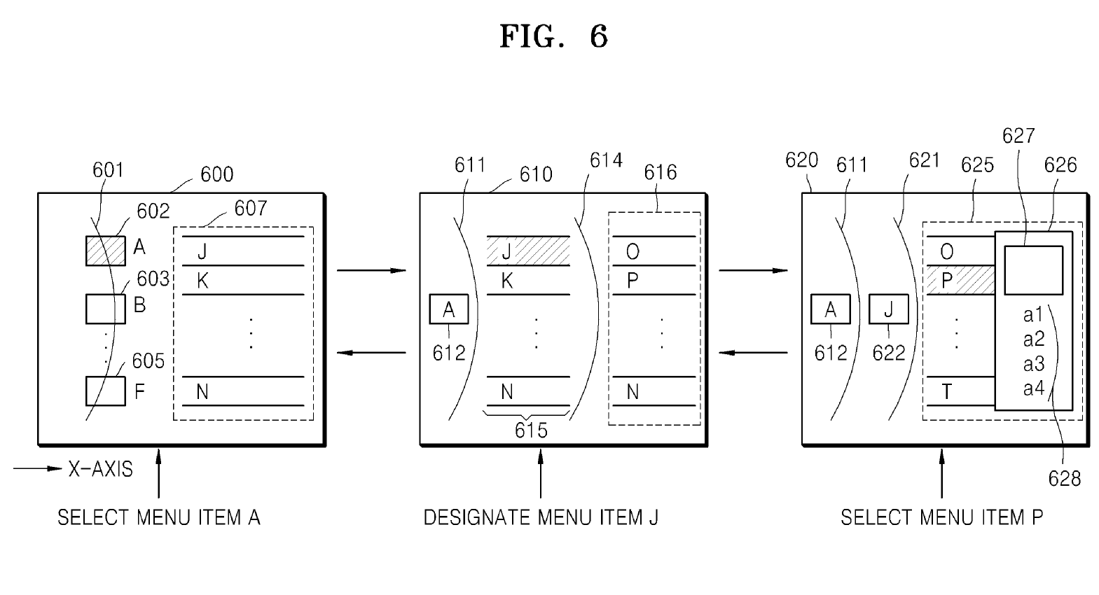

FIG. 6 is a diagram illustrating screens of the UI 101, according to another exemplary embodiment of the present invention.

A screen 600 is similar to the screen 200 of FIG. 2. In other words, in the screen 600, menu items A 602 through F 605, which are top menu items, are arranged based on an arc type line 601 and lower layer menu items of the menu item A 602 are displayed in a preview area 607, as the menu item A 602 is designated from among the menu items A 602 through F 605.

When the menu item A 602 is selected in the screen 600, the screen 600 is changed to the screen 610. As described in FIG. 2, a display location of the arc type line 601 in the screen 600 is moved to the left in the screen 610. Accordingly, a display area in an x-axis direction of an inner side of an arc type line 611 is smaller than a display area in the x-axis direction of an inner side of the arc type line 601. An icon of a selected menu item A 612 is displayed on the inner side of the arc type line 611, and other unselected menu items are not displayed. Lower layer menu items of the selected menu item A 612 are displayed in an area 615 between an outer side of the arc type line 611 and an inner side of an arc type line 614. Lower layer menu items of a menu item J designated from among menu items in the area 615 are displayed in a preview area 616.

When the menu item J is selected in the screen 610, the screen 610 is converted to the screen 620. In the screen 620, only the selected menu item A 612 is displayed on the inner side of the arc type line 611, and other menu items are not displayed. Also, only a selected menu item J 622 is displayed on an inner side of an arc type line 621, and other menu items in the same layer are not displayed. Accordingly, a display area in the x-axis direction between the arc type line 611 and the arc type line 621 in the screen 620 is smaller than a display area in the x-axis direction between the arc type line 611 and the arc type line 614 in the screen 610. Meanwhile, a display area in the x-axis direction of an area 625, which is changed to a selectable area, increases.

When a menu item P is selected from the screen 620 and lower layer menu items of the menu item P are the lowest layer menu items, the lower layer menu items of the selected menu item P are provided in a pop-up screen 626 as illustrated in the screen 620. When the menu item P in the screen 620 is a content menu item, the lower layer menu items in the pop-up screen 626 may be detailed information about the menu item P. In other words, image information 627 about content to be provided may be provided in a static image or a moving image. a1, a2, a3, and a4 628 may be information for identifying reproduction condition information or contents of the menu item P. For example, information that the menu item P is provided via a universal serial bus (USB) port and photographed on 27 March may be provided.

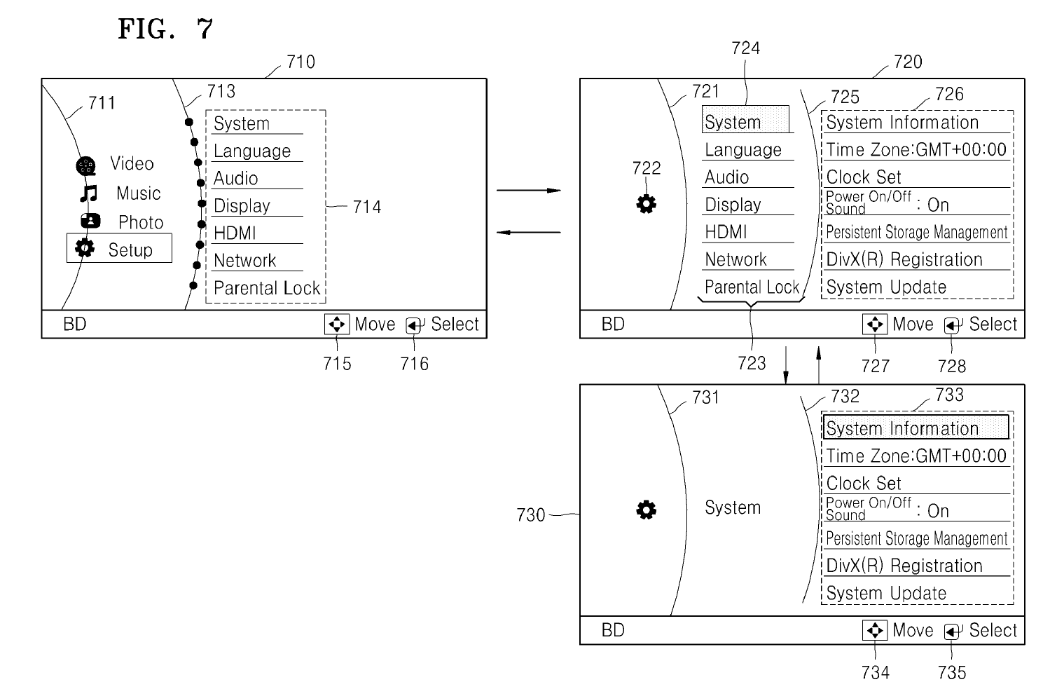

FIG. 6, as described above, and FIGS. 7 through 9, that will be described below, illustrate examples of screens displaying arc type lines between menu items having an upper and lower layer relationship. Accordingly, whenever a menu item is selected from each layer, a location of an arc type line (for example, the arc type lines 614 and 621 in FIG. 6) of a corresponding layer of the selected menu item may vary so that a display area of the layer of the selected menu item is reduced.

FIG. 7 is a diagram illustrating the application of the screens 600, 610, and 620 of FIG. 6 in a blu-ray disc (BD) system, according to an exemplary embodiment of the present invention.

In a screen 710, menu items ‘Video’, ‘Music’, ‘Photo’, and ‘Setup’, which are top menu items, are arranged based on an arc type line 711, and the menu item ‘Setup’ is designated. Accordingly, menu items displayed in a preview area 714 are lower layer menu items of the menu item ‘Setup’. The screen 710 is different from the screen 600 of FIG. 6 as an arc type line 713 is displayed between the top menu items arranged based on the arc type line 711 and the preview area 714.

When the menu item ‘Setup’ is selected in the screen 710, the menu screen of the UI 101 is converted from the screen 710 to a screen 720.

In the screen 720, an icon of the selected menu item ‘Setup’ 722 is displayed on an inner side of an arc type line 721, and the preview area 714 displaying the lower layer menu items of the menu item ‘Setup’ is changed to a selectable area 723. In the screen 720, a menu item ‘System’ 724 is designated from among the lower layer menu items of the menu item ‘Setup’ 722, and lower layer menu items of the designated menu item ‘System’ 724 are displayed in a preview area 726 in an outer side of an arc type line 725.

The arc type line 721 of the screen 720 corresponds to the arc type line 713 of the screen 710. In FIG. 720, the arc type line 711 of the screen 710 is not displayed, and a display location of the arc type line 721 is moved more to the left compared to a display location of the arc type line 713 of the screen 710. Accordingly, a display area of the inner side of the arc type line 721 of the screen 720 is smaller than a display area of the inner side of the arc type line 713 of the screen 710.

Also, as the arc type line 725 is displayed, the preview area 726 displays the lower layer menu items of the menu item ‘System’ 724.

When the menu item ‘System’ 724 is selected in the screen 720, the menu screen of the UI 101 is converted from the screen 720 to a screen 730. In the screen 730, a menu item name of the menu item ‘System’ 724 is displayed on an inner side of an arc type line 732, but other menu items are not displayed. An arc type line 731 of the screen 730 corresponds to the arc type line 721 of the screen 720, and the arc type line 732 corresponds to the arc type line 725 of the screen 720. However, a display location of the arc type line 732 in the screen 730 may be moved so that a distance between the arc type lines 731 and 732 in the screen 730 is smaller than a distance between the arc type lines 721 and 725 in the screen 720. As the menu item ‘System’ 724 is selected, the preview area 726 is converted to a selectable area 733 in the screen 730.

The operations described in FIG. 7 may be performed by using move keys 715, 727, and 734 and select keys 716, 728, and 735 in each of the screens 710, 720, and 730, respectively. Also, when a signal requesting to return to a previous screen is received, the menu screen of the UI 101 may return to a previous screen as described in FIG. 2.

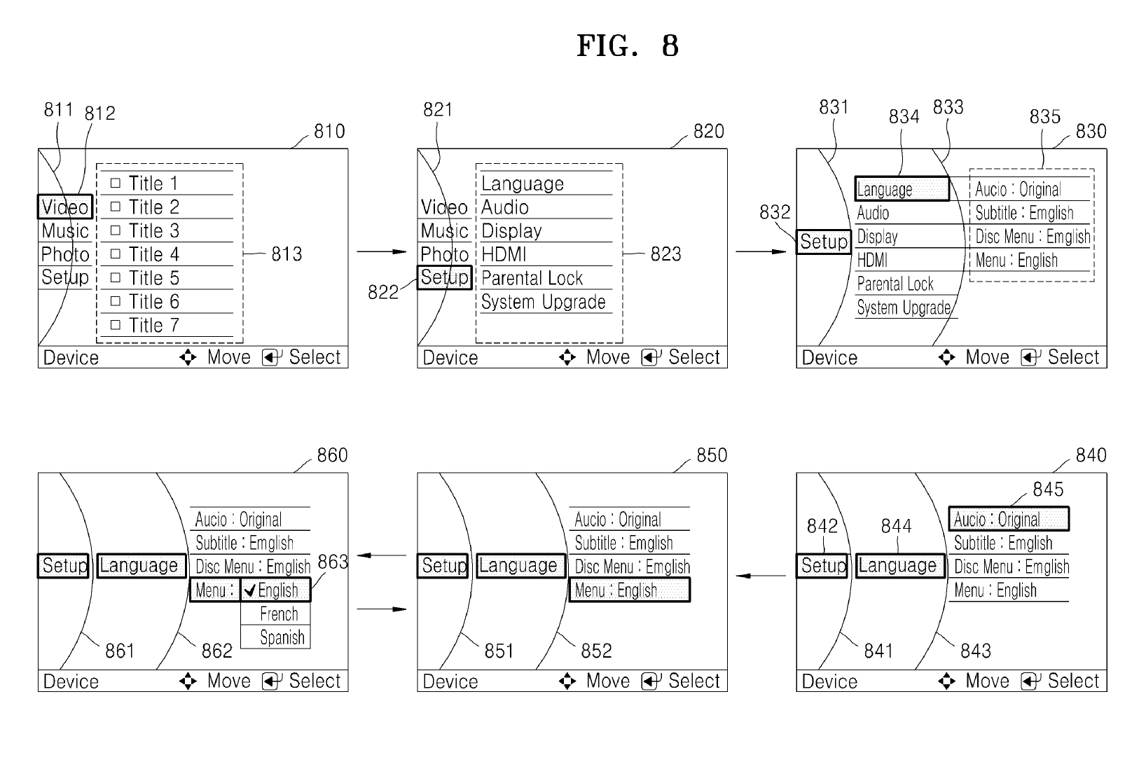

FIG. 8 is a diagram illustrating the application of the screens 600, 610, and 620 of FIG. 6 in a blu-ray disc system, according to another exemplary embodiment of the present invention. FIG. 8 is similar to FIG. 7, but another menu item is designated in FIG. 8.

In other words, in a screen 810, a menu item ‘Video’ 812 is designated from among menu items ‘Video’, ‘Music’, ‘Photo’, and ‘Setup’, which are top menu items. Accordingly, information displayed in a preview area 813 comprises lower layer menu items of the menu item ‘Video’ 812. When a designated menu item is changed from the menu item ‘Video’ 812 to the menu item ‘Setup’ in the screen 810, the screen 810 is converted to a screen 820. Accordingly, information displayed in a preview area 823 is lower layer menu items of a menu item ‘Setup’ 822. When the menu item ‘Setup’ 822 is selected in the screen 820, the screen 820 is converted to a screen 830. In the screen 830, the preview area 823 is converted to a selectable area, a menu item ‘Language’ 834 is designated, and a preview area 835 displays lower layer menu items of the menu item ‘Language’ 834 on an outer side of an arc type line 833. The icon of the selected menu item ‘Setup’ 832 is displayed on an inner side of an arc type line 831.

When the menu item ‘Language’ 834 is selected in the screen 830, the screen 830 is converted to a screen 840. In screen 840, the selected menu item ‘Language’ 844 is displayed on an inner side of an arc type line 843 and the selected menu item ‘Setup’ 842 is displayed on an inner side of an arc type line 841. In the screen 840, a lower layer menu item ‘Audio: Original’ 845 is designated. Here, when a move down key is manipulated three times, the screen 840 is converted to a screen 850. When a menu item ‘Menu’ is designated in the screen 850, the screen 850 is converted to a screen 860. In the screen 860, a pop-up screen 863 displays lowest layer menu items.

Display locations of each of arc type lines 811, 821, 831, 833, 841, 843, 851, 852, 861, and 862 may change according to a menu item selected in each layer. In other words, the display locations of the arc type lines 811, 821, 831, 833, 841, 843, 851, 852, 861, and 862 may change so that a corresponding display area of the menu item is reduced.

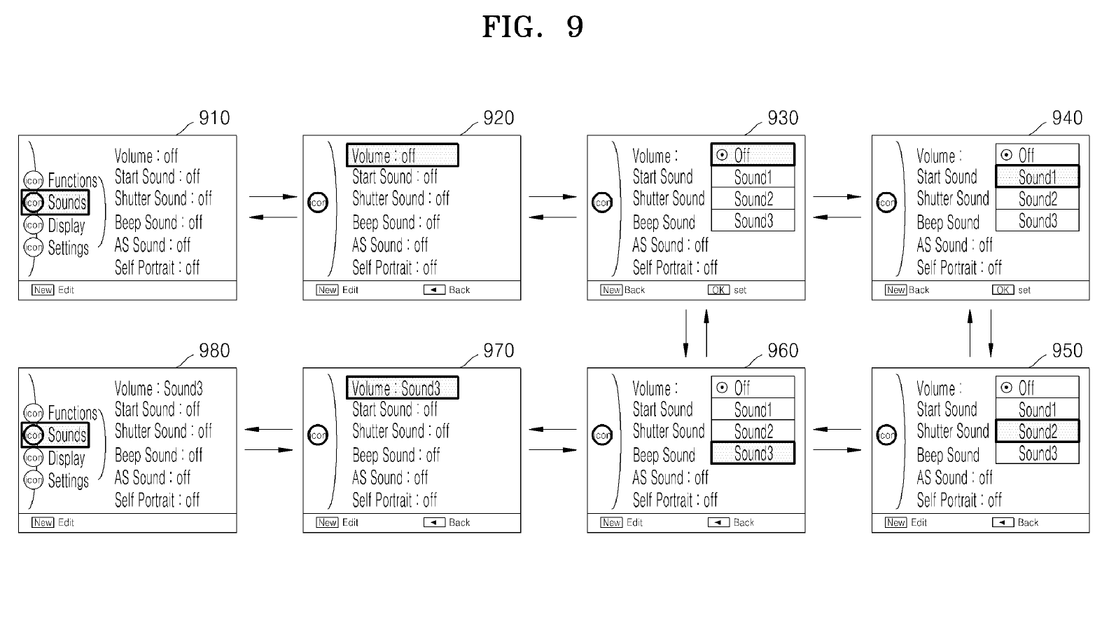

FIG. 9 is a diagram illustrating the application of the screens 600, 610, and 620 of FIG. 6 in a digital still camera, according to an exemplary embodiment of the present invention. When a menu item ‘Sounds’ is selected from among top menu items displayed on a screen 910, the screen 910 is converted to a screen 920. In the screen 920, a menu item name of the menu item ‘Sounds’ is displayed on an inner side of an arc type line, and other menu items in the same layer are not displayed. Also, when a menu item ‘Volume’ is selected from among lower layer menu items of the menu item ‘Sounds’ in the screen 920, the screen 920 is converted to a screen 930. In the screen 930, lower layer menu items of the menu item ‘Volume’ are displayed in a pop-up screen.

In the screen 930, when a command for designating a menu item to be displayed on the pop-up screen as a menu item ‘Sound1’ is input, the menu screen of the UI 101 is converted from the screen 930 to a screen 940. In the screen 940, when a command for designating a menu item to be displayed on the pop-up screen as a menu item ‘Sound2’ is input, the menu screen of the UI 101 is converted from the screen 940 to a screen 950. In the screen 950, when a command for designating a menu item to be displayed on the pop-up screen to be a menu item ‘Sound3’ is input, the menu screen of the UI 101 is converted from the screen 950 to a screen 960. In the screen 930, when a command for designating a menu item to be displayed on the pop-up screen as a menu item ‘Sound3’ is input, the menu screen of the UI 101 is converted from the screen 930 to a screen 960. Such commands may be input by using a control key displayed on the UI 101 or a remote controller.

When the assigned ‘Sound3’ is selected in the screen 960, the screen 960 is converted to a screen 970. In the screen 970, a lowest layer menu item is selected. The screen 970 may be converted to a screen 980. The screen 980 is identical to the screen 310 of FIG. 3. That is, in the screen 980, selecting a lowest layer menu item of the selected menu item ‘Sounds’ is completed, and thus the top menu items including the selected menu item ‘Sounds’ are arranged based on an arc type line, and information about the selected menu items is displayed.

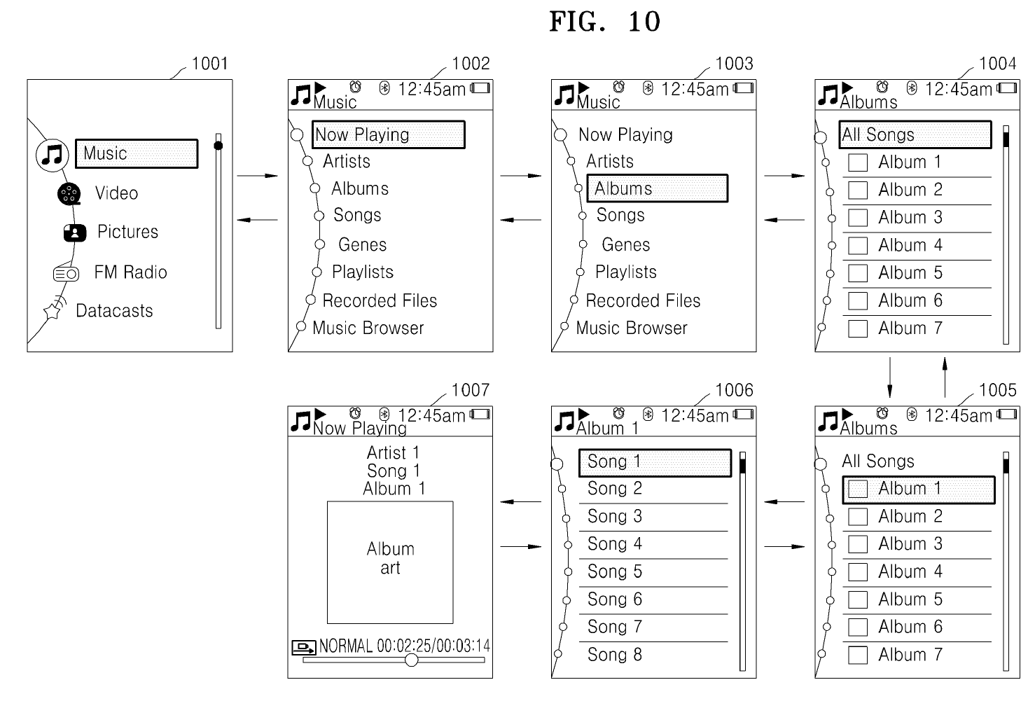

FIG. 10 is a diagram illustrating the application of a screen of a UI in an MP3P, according to an exemplary embodiment of the present invention.

A screen 1001 displays top menu items based on an arc type line. When a menu item ‘Music’ is selected in the screen 1001, the menu screen of the UI 101 is converted from the screen 1001 to a screen 1002. Menu items displayed on the screen 1002 are lower layer menu items of the menu item ‘Music’, and are displayed based on an arc type line.

When a menu item ‘Albums’ is designated in the screen 1002, the screen 1002 is converted to a screen 1003. When the menu item ‘Albums’ is selected in the screen 1003, the screen 1003 is converted to a screen 1004. Lower layer menu items of the menu item ‘Albums’ are arranged based on an arc type line in the screen 1004.

When a menu item ‘Album 1’ is designated in the screen 1004, the screen 1004 is converted to a screen 1005. When the menu item ‘Album 1’ is selected in the screen 1005, the screen 1005 is converted to a screen 1006. Lower layer menu items of the menu item ‘Album 1’ are arranged based on an arc type line in the screen 1006. In other words, all songs registered in the menu item ‘Album 1’ are the lower layer menu items of the menu item ‘Album 1’.

When a menu item ‘Song 1’ is selected in the screen 1006, the menu screen of the UI 101 is converted from the screen 1006 to a screen 1007. A user may reproduce selected content while viewing information about lowest menu items from top menu items about the selected content via the screen 1007.

In order to display the screens of FIGS. 2 through 10 on the UI 101, the controller 102 provides screens controlled or adjusted based on an associated relationship between information received via the UI 101 or the remote controller and menu items provided from the menu management unit 103 to the UI 101. Accordingly, it can be said that the controller 102 controls or adjusts the menu screen displayed on the UI 101.

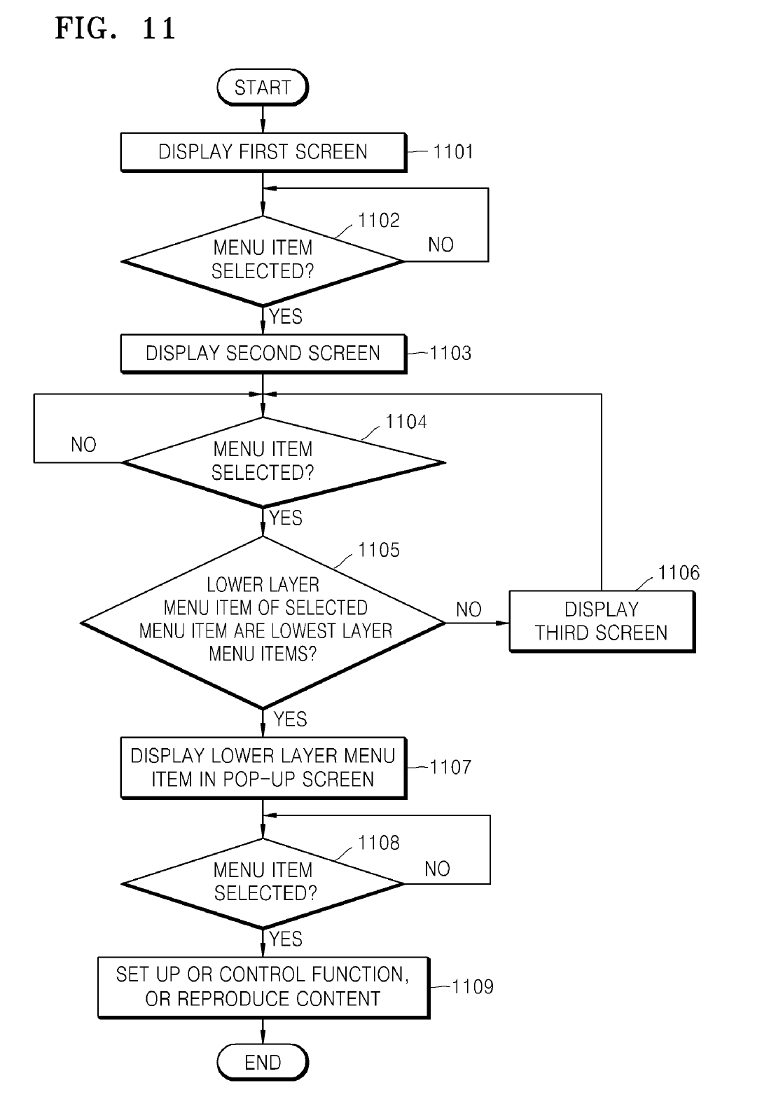

FIG. 11 is a flowchart of a menu navigation method, according to an exemplary embodiment of the present invention. Referring to FIG. 11, the menu navigation method is performed as follows.

When a menu screen is requested, a first screen is displayed in operation 1101. The first screen is the same screen as the first screens of FIGS. 1 through 10, and at least one menu item is arranged based on an arc type line. Also, the first screen may include a preview area on which lower layer menu items of a designated menu item are arranged based on the arc type line. When the first screen includes the preview area, a user may consider whether to select the designated menu item as the lower layer menu items are displayed.

When one menu item is selected in the first screen in operation 1102, a second screen is displayed in operation 1103. The second screen is similar to the screen 610 of FIG. 6. In other words, in the second screen, menu items other than the menu item selected from among the at least one menu items arranged based on the arc type line are not displayed, one of an icon or a menu item name of the selected menu item is displayed on an inner side of the arc type line, and the preview area is changed to a selectable area. Here, as described in relation to FIGS. 2 and 6, a display area in an x-axis direction of the inner side of the arc type line may be reduced, and a display area in the x-axis direction of the selectable area may be increased. Accordingly, the display areas are efficiently managed so that unnecessary information is not displayed and a menu item selected by a user is conveniently obtained.

When one menu item is selected in the second screen in operation 1104, it is determined whether lower layer menu items of the selected menu item are lowest layer menu items in operation 1105. Whether the lower layer menu items of the selected menu item are lowest layer menu items is determined based on layer association relation information provided from the menu management unit 103. When it is determined that the lower layer menu items of the selected menu item are not lowest layer menu items, a third screen like the screen 620 of FIG. 6 is displayed in operation 1106, and then operation 1104 is performed again.

However, when the lower layer menu items of the selected menu item are lowest layer menu items, the lower layer menu items are displayed in a pop-up screen in operation 1107.

The pop-up screen may be provided as the screen 220 of FIG. 2 or the screen 620 of FIG. 6. When a menu item is selected based on the pop-up screen in operation 1108, a function of the selected menu item is set up or controlled, or content is reproduced in the apparatus 100 in operation 1109.

The invention can also be embodied as computer readable codes on a computer readable storage medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A menu navigation method, comprising:
displaying a first screen on which at least one menu item is arranged based on an arc type line; and
when a menu item is selected based on the first screen, displaying a second screen on which the selected menu item is displayed on an inner side of the arc type line and at least one menu item is arranged on an outer side of the arc type line,
wherein the at least one menu item arranged on the outer side of the arc type line of the second screen is at least one lower layer menu item of the selected menu item.

2. The menu navigation method of claim 1, wherein when each of the first screen and the second screen includes a lower layer menu item of a designated menu item from among the displayed at least one menu item, each of the first screen and the second screen includes a preview area displaying the lower layer menu item,
wherein the menu navigation method further comprises when the designated menu item is selected, changing the preview area to a selectable area.

3. The menu navigation method of claim 2, further comprising when the preview area is changed to the selectable area, changing a display location of the arc type line so that a display area of the inner side of the arc type line is reduced.

4. The menu navigation method of claim 3, further comprising displaying a lowest layer menu item of the menu item selected in the first screen as a pop-up screen.

5. The menu navigation method of claim 4, further comprising displaying the menu item, the lower layer menu item, or the lowest layer menu item designated in the first screen, the second screen, or the pop-up screen differently from undesignated menu items in the first screen, the second screen, or the pop-up screen.

6. The menu navigation method of claim 5, wherein the displaying the first screen comprises displaying at least one of a menu item name and an icon of the at least one menu item arranged based on the arc type line, and
wherein the displaying the second screen comprises displaying at least one of a menu item name and an icon of the selected menu item on the inner side of the arc type line.

7. The menu navigation method of claim 6, further comprising when the lowest layer menu item of the selected menu item is selected, displaying a third screen, on which the lowest layer menu item of a lowest layer and the selected menu item are arranged based on an arc type line of the lowest layer and includes information about the selected menu item.

8. The menu navigation method of claim 4, further comprising when the lowest layer menu item of the selected menu item is selected, displaying a third screen, on which the lowest layer menu item of a lowest layer and the selected menu item are arranged based on an arc type line of the lowest layer and includes information about the selected menu item.

9. The menu navigation method of claim 2, further comprising displaying an arc type line between upper layer menu items and lower layer menu items.

10. The menu navigation method of claim 9, further comprising when a menu item is selected from a top layer, a lower layer, or a lowest layer, changing a location of an arc type line of the top layer, the lower layer, or the lowest layer corresponding to the selected menu item so as to reduce a display area of the top layer, the lower layer, or the lowest layer corresponding to the selected menu item.

11. The menu navigation method of claim 10, further comprising displaying the lowest layer menu item of the menu item selected in the first screen as a pop-up screen.

12. The menu navigation method of claim 11, further comprising displaying the menu item designated in the first screen, the second screen, or the pop-up screen differently from undesignated menu items in the first screen, the second screen, or the pop-up screen.

13. The menu navigation method of claim 12, further comprising:
displaying at least one of a menu item name and an icon of the at least one menu item arranged based on each arc type line; and
displaying at least one of a menu item name and an icon of the selected menu item on an inner side of each arc type line.

14. The menu navigation method of claim 13, further comprising when the lowest layer menu item of the selected menu item is selected, displaying a third screen, on which the selected menu item is arranged based on an arc type line of the lowest layer and includes information about the selected menu item.

15. The menu navigation method of claim 11, further comprising when the lowest layer menu item of the selected menu item is selected, displaying a third screen, on which the selected menu item is arranged based on an arc type line of the lowest layer and includes information about the selected menu item.

16. A user interface (UI) comprising:
displaying a first screen on which at least one menu item is arranged based on an arc type line; and
when a menu item is selected based on the first screen, displaying a second screen on which the selected menu item is displayed on an inner side of the arc type line and at least one menu item is arranged on an outer side of the arc type line,
wherein the at least one menu item arranged on the outer side of the arc type line of the second screen is at least one lower layer menu item of the selected menu item.

17. The UI of claim 16, wherein when each of the first screen and the second screen includes a lower layer menu item of a designated menu item from among the displayed at least one menu item, each of the first screen and the second screen includes a preview area displaying the lower layer menu item,
wherein the UI further comprises when the designated menu item is selected, changing the preview area to a selectable area.

18. The UI of claim 17, further comprising when the preview area is changed to the selectable area, changing a display location of the arc type line so that a display area of the inner side of the arc type line is reduced.

19. The UI of claim 18, further comprising displaying a lowest layer menu item of the menu item selected in the first screen as a pop-up screen.

20. The UI of claim 19, further comprising displaying a menu item designated in the first screen, the second screen, or the pop-up screen differently from undesignated menu items in the first screen, the second screen, or the pop-up screen.

21. The UI of claim 20, wherein the displaying the first screen comprises displaying at least one of a menu item name and an icon of the at least one menu item arranged based on the arc type line, and
wherein the displaying the second screen comprises displaying at least one of a menu item name and an icon of the selected menu item on the inner side of the arc type line.

22. The UI of claim 21, further comprising when the lowest layer menu item of the selected menu item is selected, displaying a third screen, on which the lowest layer menu item and the selected menu item are arranged based on an arc type line of the lowest layer and includes information about the selected menu item.

23. The UI of claim 19, further comprising when the lowest layer menu item of the selected menu item is selected, displaying a third screen, on which the lowest layer menu item e and the selected menu item are arranged based on an arc type line of the lowest layer and includes information about the selected menu item.

24. The UI of claim 17, further comprising displaying an arc type line between upper layer menu items and lower layer menu items.

25. The UI of claim 24, further comprising when a menu item is selected from a top layer, a lower layer, or a lowest layer, changing a location of an arc type line of the top layer, the lower layer, or the lowest layer corresponding to the selected menu item so as to reduce a display area of the top layer, the lower layer, or the lowest layer corresponding to the selected menu item.

26. The UI of claim 25, further comprising displaying the lowest layer menu item of the menu item selected in the first screen as a pop-up screen.

27. The UI of claim 26, further comprising displaying the menu item designated in the first screen, the second screen, or the pop-up screen differently from undesignated menu items in the first screen, the second screen, or the pop-up screen.

28. The UI of claim 27, further comprising:
displaying at least one of a menu item name and an icon of the at least one menu item arranged based on each arc type line; and
displaying at least one of a menu item name and an icon of the selected menu item on an inner side of each arc type line.

29. The UI of claim 28, further comprising when the lowest layer menu item of the selected menu item is selected, displaying a third screen, on which the selected menu item is arranged based on an arc type line of the lowest layer and includes information about the selected menu item.

30. The UI of claim 26, further comprising when the lowest layer menu item of the selected menu item is selected, displaying a third screen, on which the selected menu item is arranged based on an arc type line of the lowest layer and includes information about the selected menu item.

31. An electronic apparatus comprising:
a user interface (UI) displaying a menu screen, on which at least one menu item is arranged based on an arc type line and which displays a lower layer menu item of a menu item designated from among the at least one menu item on a preview area; and
a controller, which, when a menu item is selected from the menu screen, displays the selected menu item in an inner side of the arc type line and provides information about changing the preview area to a selectable area to the UI.

32. The electronic apparatus of claim 31, further comprising a menu management unit which stores and manages selectable menu items that are classified according to menu items in a hierarchical structure,
wherein the controller provides information about a screen formed according to menu item information obtained from the menu management unit to the UI, based on received information.

33. A computer readable recording medium having recorded thereon a program for executing a menu navigation method comprising:
displaying a first screen on which at least one menu item is arranged based on an arc type line; and
when a menu item is selected based on the first screen, displaying a second screen on which the selected menu item is displayed on an inner side of the arc type line and at least one menu item is arranged on an outer side of the arc type line,
wherein the at least one menu item arranged on the outer side of the second screen is at least one lower layer menu item of the selected menu item.

34. The recording medium of claim 33, wherein when each of the first screen and the second screen includes a lower layer menu item of a designated menu item from among the displayed at least one menu item, each of the first screen and the second screen includes a preview area displaying the lower layer menu item, wherein the menu navigation method further comprises when the designated menu item is selected, changing the preview area to a selectable area.

35. The recording medium of claim 34, wherein the menu navigation method further comprises when the preview area is changed to the selectable area, changing a display location of the arc type line so that a display area of the inner side of the arc type line is reduced.

36. The recording medium of claim 35, wherein the menu navigation method further comprises displaying a lowest layer menu item of the menu item selected in the first screen as a pop-up screen.

37. The recording medium of claim 36, wherein the menu navigation method further comprises displaying a menu item designated in the first screen, the second screen, or the pop-up screen differently from undesignated menu items in the first screen, the second screen, or the pop-up screen.

38. The recording medium of claim 37, wherein the displaying the first screen comprises displaying at least one of a menu item name and an icon of the at least one menu item arranged based on the arc type line, and
wherein the displaying the second screen comprises displaying at least one of a menu item name and an icon of the selected menu item on the inner side of the arc type line.

39. The recording medium of claim 38, wherein the menu navigation method further comprises when the lowest layer menu item of the selected menu item is selected, displaying a third screen, on which the lowest layer menu item and the selected menu item are arranged based on an arc type line of the lowest layer and includes information about the selected menu item.

40. The recording medium of claim 36, wherein the menu navigation method further comprises when the lowest layer menu item of the selected menu item is selected, displaying a third screen, on which the lowest layer menu item and the selected menu item are arranged based on an arc type line of the lowest layer and includes information about the selected menu item.

41. The recording medium of claim 33, wherein the menu navigation method further comprises displaying an arc type line between upper layer menu items and lower layer menu items.

42. The recording medium of claim 41, wherein the menu navigation method further comprises when a menu item is selected from a top layer, a lower layer, or a lowest layer, changing a location of an arc type line of the top layer, the lower layer, or the lowest layer corresponding to the selected menu item so as to reduce a display area of the top layer, the lower layer, or the lowest layer corresponding to the selected menu item.

43. The recording medium of claim 42, wherein the menu navigation method further comprises displaying the lowest layer menu item of the menu item selected in the first screen as a pop-up screen.

44. The recording medium of claim 43, wherein the menu navigation method further comprises displaying a menu item designated in the first screen, the second screen, or the pop-up screen differently from undesignated menu items in the first screen, the second screen, or the pop-up screen.

45. The recording medium of claim 44, wherein the menu navigation method further comprises:
displaying at least one of a menu item name and an icon of the at least one menu item arranged based on each arc type line; and
displaying at least one of a menu item name and an icon of the selected menu item on an inner side of each arc type line.

46. The recording medium of claim 45, wherein the menu navigation method further comprises when the lowest layer menu item of the selected menu item is selected, displaying a third screen, on which the selected menu item is arranged based on an arc type line of the lowest layer and includes information about the selected menu item.

47. The recording medium of claim 43, wherein the menu navigation method further comprises when the lowest layer menu item of the selected menu item is selected, displaying a third screen, on which the selected menu item is arranged based on an arc type line of the lowest layer and includes information about the selected menu item.
